(19) United States
(12) Patent Application Publication
(10) Pub. No.: US 2017/0282159 A1
(43) Pub. Date: Oct. 5, 2017

(54) Method for Preparing Molybdenum Doped Titanium Dioxide Thin Film by Sol-Gel

(71) Applicant: YANCHENG INSTITUTE OF TECHNOLOGY, Yancheng (CN)

(72) Inventors: QI XU, Yancheng (CN); SHUAI PAN, Yancheng (CN); XU QIAO, Nanjing (CN); MIFEN CUI, Nanjing (CN); QI ZHANG, Yancheng (CN)

(73) Assignee: YANCHENG INSTITUTE OF TECHNOLOGY

(21) Appl. No.: 15/405,311

(22) Filed: Jan. 13, 2017

(30) Foreign Application Priority Data
Mar. 30, 2016 (CN) 201610190306.7

(51) Int. Cl. B01J 23/28; B01D 53/86; B01J 37/02; B01J 37/08; B01J 35/00; B01J 37/04

(52) U.S. Cl. CPC B01J 23/28; B01J 35/0006; B01J 35/004; B01J 37/04; B01J 37/0219; B01J 37/088; B01D 53/8668; B01D 2255/802; B01D 2255/20707; B01D 2255/20769; B01D 2257/708

(57) ABSTRACT

The present invention discloses a method for preparing molybdenum doped titanium dioxide thin film by sol-gel, comprising following steps: preparing a mixed solution containing tetrabutyl titanate, adding a thickener to obtain solution I, preparing solution II containing ammonium molybdate solution, dropwise adding solution II into solution I and obtaining a titanium dioxide sol; dipping the titanium dioxide sol on the surface of a glass ball and oven drying, repeating such for several times, removing a solvent by vacuum drying, carrying out high-temperature calcination, keeping warm and obtaining molybdenum doped titanium dioxide thin film. The molybdenum doped titanium dioxide thin film prepared by the present invention has higher specific surface area, and the catalyst after modeling deposition has better transmissivity and porosity, large reaction contact area, high light efficiency and good photocatalytic effect.

### CROSS-REFERENCE TO RELATED APPLICATIONS

This application claims priority of Chinese Patent Application No. 201610190306.7 with a filing date of Mar. 30, 2016. The content of the aforementioned application, including any intervening amendments thereto, are incorporated herein by reference.

### TECHNICAL FIELD

The present invention relates to material field, and more specifically, to a method for preparing molybdenum doped titanium dioxide thin film by sol-gel.

### BACKGROUND OF THE INVENTION

In recent years, environment is under great pressure due to abuse of chemical products, such as drugs, personal care, insecticide and surface active agent, and byproducts produced from incomplete combustion of mineral fuels. Some pollutants can be evaporated into the air, related detection finds that motor vehicle exhaust, indoor decoration materials, industrial waste gas and so on contain these chemical pollutants to varying degrees, which has great influence on human's health. These pollutants remained in the environment has become a new problem to human and society and causes great attention of the public due to the characteristics of hard degradation. These pollutants have complicated structure and non-biodegradable characteristic, and cannot be removed completely or the degradation cost is higher by traditional treatment methods such as absorption, adsorption and combustion.

Studies found that performance of catalytic material is decided by its micro crystal form, morphology, structure and molecular self-assembled form. The molybdenum doped titanium dioxide thin film loaded on the surface of the glass ball has larger light contact area, better light transmissivity and higher photocatalytic activity.

Generally, combined with methods like interfacial polymerization and molecular self-assembly, titanium dioxide (TiO₂) filming technology adopts method of adding surface active agent, such as PEG, so that TiO₂ molecule forms regular and order porous film material by calcining adjustment.

Existing methods for preparing titanium dioxide thin film mainly include direct hydrolysis method, sol-gel method, hydrothermal method, ultrasonic irradiation method etc., and in preparation process, surface active agent is added as the thickener or template to avoid particle aggregation and prevent crack in drying and calcination process. Templates for preparing titanium dioxide mainly include: cetyl trimethyl ammonium bromide (CTAB), polyvinyl alcohol (PVA), block copolymer (P123) and polyethylene glycol (PEG). Existing methods for preparing titanium dioxide thin film exist following problems:

1. The preparation process of catalyst is complicated, and many uncontrollable factors are existed in preparation process;

2. The pore of preparing titanium dioxide thin film is not regular and the structure is uncontrollable;

3. The forming process of catalyst is not good for increase of photocatalytic reaction performance.

Chinese patent CN102258996A discloses preparation of molybdenum doped titanium dioxide powder by sol-gel method, and the method is long in preparation time, and prepared titanium dioxide becomes powder after grinding, which has disadvantages of small specific surface area, small reaction contact area and low light efficiency. And CN101659519B discloses a method for preparing modified titanium dioxide doped thin film, and the method comprises the following steps: preparing an early modified titanium dioxide doped thin film by the layer-by-layer self-assembly technique on glass base, then obtaining the modified titanium dioxide doped thin film by heat treatment. The preparation method can assemble modified titanium dioxide doped thin film on the glass base firmly, and realize production of large area thin film, however, in earlier stage, complicated activated pre-treatment needs to be carried out on the glass base.

### SUMMARY OF THE INVENTION

To overcome deficiencies existing in the prior art, the present invention provides a method for preparing molybdenum doped titanium dioxide thin film by sol-gel. The molybdenum doped titanium dioxide thin film prepared by the present invention has higher specific surface area, and the catalyst after modeling deposition has better transmissivity and porosity to solve the deficiencies of small reaction contact area and low lighting efficiency of nano TiO₂ powder catalytic material and increase photocatalylic activity of material.

To realize above purpose, the present invention adopts following technical scheme.

A method for preparing molybdenum doped titanium dioxide thin film by sol-gel, comprising following steps:

(1) preparing a mixed solution by mixing tetrabutyl titanate, acetylacetone and anhydrous ethanol, stirring and mixing the mixed solution evenly;

(2) adding a thickener into the mixed solution obtained in step (1), stirring to complete dissolution under 20-50° C. and obtaining a solution I;

(3) mixing ammonium molybdate solution, deionized water and anhydrous ethanol, adjusting pH value to 4-6 by nitric acid, stirring sufficiently and mixing evenly, and obtaining a solution II;

(4) dropwise adding the solution II obtained in step (3) into the solution I obtained in step (2) under vigorous stirring to hydrolyze the tetrabutyl titanate completely, after the completion, continually stirring for 2 hours and obtaining faint yellow, uniform and transparent titanium dioxide sol, the obtained titanium dioxide sol is stable under room temperature, and not easily to form gel;

(5) immersing a glass ball into the titanium dioxide sot obtained in step (4) completely, loading the titanium dioxide sot on the glass ball surface by dipping coating method, oven drying in an air dry oven, immersing into the titanium dioxide sol again, oven drying again, repeating such for several times, taking multiple dipped and dried titanium dioxide sol down, placing into a vacuum drying oven for completely drying, and evaporating a solvent completely;

(6) placing the evaporated titanium dioxide sol obtained in step (5) in a muffle furnace and carrying out high-temperature calcination, taking out after cooling completely, and obtaining molybdenum doped titanium dioxide thin film.

Preferably, the volume ratio of the tear butyl titanate, the acetylacetone and the anhydrous ethanol in step (1) 0.1-0.3:4-8

Preferably, the mixed solution is stirred for 0.5-1 hour by a magnetic stirrer under room temperature for stirring and mixing the mixed solution evenly in step (1).

Preferably, the thickener in step (2) is one of polyvinyl alcohol and polyethylene glycol, and the preferred one is polyethylene glycol (PEG), such as PEG 200, PEG 400, PEG 800, PEG 1000, PEG2000 etc. Moderate PEG can prevent infiltration in painting process, so that the thin film has better load performance, and PEG is easily to be decomposed and carbonized in heat treatment process, which is good for opening of the thin film.

Preferably, the dosage of the thickener in step (2) is 1-3 mL for each 10 mL pure tetrabutyl titanate. The dosage of the thickener will affect the property of TiO₂ sol film formed on the surface of the glass ball, thereby changing porous structure, aperture size and specific surface area of TiO₂ thin film and affecting the photocatalytic activity.

Preferably, the concentration of ammonium molybdate solution in step (3) is 0.1 g/mL, the mass concentration of nitric acid is 65 wt %, and the solution II is mixed by different volume of ammonium molybdate solution, deionized water and anhydrous ethanol according to molybdenum doping content, and adjusting pH by nitric acid.

Preferably, the dropwise adding speed in step (4) is 30-50 drops per minute.

Preferably, the diameter of the, glass ball in step (5) is 3-5 mm, and the glass ball is used for catalytic reaction of fixed-bed after dipping thin film, which has better porosity, light transmissivity and large reaction contact area.

Preferably, in step (5), the oven drying temperature for each time is 80° C., the oven drying time is 10 min, and the repeated times are 5-7; the drying temperature is 80° C. and drying time is 8-12 h.

Preferably, the high-temperature calcination in step (6) is under 300-600° C. and the calcination time is 3-6 hours. The crystal form, porous structure and opening degree of molybdenum doped TiO₂ thin film can be controlled efficiently by changing the calcination temperature.

Compared with prior art, the molybdenum doped titanium dioxide thin film prepared by the present invention has following advantages:

(1) The molybdenum doped titanium dioxide thin film prepared by the present invention has higher specific surface area, and the catalyst after modeling deposition has better transmissivity and porosity to solve the deficiencies of small reaction contact area and low lighting efficiency of nano TiO₂ powder catalytic material and increase photocatalytic activity of material.

(2) The present invention adopts dipping coating method to dip titanium dioxide sol on the glass ball for many times and oven dry, and the glass ball has no need to be activated pre-treatment, so the method is simple and controllable.

(3) The molybdenum doped titanium dioxide thin film prepared by the present invention has excellent catalytic performance in degrading volatile organic compounds (VOCs).

### DETAILED DESCRIPTION OF THE INVENTION

The present invention is further described with reference embodiments.

### Embodiment 1

Preparation of 1% (n(Mo):n(Ti)=1%) molybdenum doped titanium dioxide thin film, and this embodiment comprises following steps:

(1) preparing a mixed solution by mixing 30 mL tetrabutyl titanate, 5 mL acetylacetone and 90 mL anhydrous ethanol, stirring and mixing the mixed solution evenly, and the stirring time is 0.5 hour;

(2) adding 5 mL thickener polyethylene glycol (PEG 200) into above stirred mixed solution, and stirring under 20-50° C. for complete dissolution and obtaining a solution I;

(3) mixing 1.55 mL and 0.1 g/mL ammonium molybdate solution, 6.2 mL deionized water and 45 mL anhydrous ethanol, adjusting pH value to 4-6 by dropwise adding nitric acid with concentration of 65%, stirring sufficiently and mixing evenly, and obtaining a solution II;

(4) dropwise adding the solution II into the solution I obtained in step (2 at a speed of 30-50 drops per minute under vigorous stirring to hydrolyze the tetrabutyl titanate completely, continually stirring for 2 hours and obtaining faint yellow, uniform and transparent titanium dioxide sol;

(5) immersing 3-5 mm glass ball into the above sol completely, loading the sol on the surface of the glass ball by dipping coating method, drying for 10 min in the air dry oven under 80° C., immersing dried glass ball into above sol, taking out and drying for 10 min in the air dry oven under 80° C. again, repeating such for 5-7 times, taking the obtained titanium dioxide sol down, placing in the air dry oven under 80° C. for completely drying for 8-12 hours and evaporating the solvent completely;

(6) placing the titanium dioxide sol obtained in step (5) in the muffle furnace, high-temperature calcining under 300-600° C. and keeping warm for 3-6 hours, taking out after cooling sufficiently, and obtaining 1% molybdenum doped titanium dioxide thin film.

### Embodiment 2

Preparation of 2% (n(Mo):n(Ti)=2%) molybdenum doped titanium dioxide thin film, and this embodiment comprises following steps:

(1) preparing a mixed solution by mixing 30 mL tetrabutyl titanate, 5 mL acetylacetone and 90 mL anhydrous ethanol, stirring and mixing the mixed solution evenly, and the stirring time is 0.5 hour;

(2) adding 5 mL thickener polyethylene glycol (PEG200) into above stirred mixed solution, and stirring under 20-50° C. for completely dissolution, and obtaining a solution I;

(3) mixing 3.1 mL and 0.1 g/mL ammonium molybdate solution, 4.65 mL deionized water and 45 mL anhydrous ethanol, adjusting pH value to 4-6 by dropwise adding nitric add with concentration of 65%, stirring sufficiently and mixing evenly, and obtaining a solution II;

(4) dropwise adding the solution II into the solution I obtained in step (2) at a speed of 30-50 drops per minute under vigorous stirring to hydrolyze the tetrabutyl titanate completely, continually stirring for 2 hours and obtaining faint yellow, uniform and transparent titanium dioxide sol;

(5) immersing 3-5 mm glass ball into above sol completely, loading the sol on the surface of the glass ball by dipping coating method, drying for 10 min in the air dry oven under 80° C., immersing dried glass ball into above sol, taking out and drying for 10 min in the air dry oven under 80° C. again, repeating such for 5-7 times, placing the obtained titanium dioxide sol in the air dry oven under 80° C. for completely drying for 8-12 hours and evaporating the solvent completely;

(6) placing the titanium dioxide sol obtained in step (5) in the muffle furnace, high-temperature calcining under 300-600° C. and keeping warm for 3-6 hours, taking out after cooling sufficiently, and obtaining 2% molybdenum doped titanium dioxide thin film.

### Embodiment 3

Preparation of 3% (n(Mo):n(Ti)=3%) molybdenum doped titanium dioxide thin film, and this embodiment comprises following steps:

(1) preparing a mixed solution by mixing 30 mL tetrabutyl titanate, 5 mL acetylacetone and 90 mL anhydrous ethanol, stirring and mixing the mixed solution evenly, and the stirring time is 0.5 hour;

(2) adding 5 mL thickener polyethylene glycol (PEG200) into above stirred mixed solution, and stirring under 20-50° C. for completely dissolution, and obtaining a solution I;

(3) mixing 4.65 mL, and 0.1 g/ml, ammonium molybdate solution, 3.1 ml deionized water and 45 mL anhydrous ethanol, adjusting pH value to 4-6 by dropwise adding nitric acid with concentration of 65%, stirring sufficiently and mixing evenly, and obtaining a solution II;

(4) dropwise adding the solution II into the solution I obtained in step (2) at a speed of 30-50 drops per minute under vigorous stirring to hydrolyze the tetrabutyl titanate completely, continually stirring for 2 hours and obtaining faint yellow, uniform and transparent titanium dioxide sol;

(5) immersing 3-5 mm glass ball into the above sol completely, loading the sol on the surface of the glass ball by dipping coating method, drying for 10 min in the air dry oven under 80° C., immersing dried glass bail into above sol, taking out and drying for 10 min in the air dry oven under 80° C. again, repeating such for 5-7 times, placing the obtained titanium dioxide sol in the air dry oven under 80° C. for completely drying for 8-12 hours and evaporating the solvent completely;

(6) placing the titanium dioxide sol obtained in step (5) in the muffle furnace, high-temperature calcining under 300-600° C. and keeping warm for 3-6 hours, taking out after cooling sufficiently, and obtaining 3% molybdenum doped titanium dioxide thin film.

### Embodiment 4

Preparation of 3.5% (n(Mo):n(Ti)=3.5%) molybdenum doped titanium dioxide thin film, and this embodiment comprises following steps:

(1) preparing a mixed solution by mixing 30 mL tetrabutyl titanate, 5 mL acetylacetone and 90 mL anhydrous ethanol, stirring and mixing the mixed solution evenly, and the stirring time is 0.5 hour;

(2) adding 5 mL thickener polyethylene glycol (PEG200) into above stirred mixed solution, and stirring under 20-50° C. for completely dissolution, and obtaining a solution I;

(3) mixing 5.4 mL and 0.1 g/mL ammonium molybdate solution, 2.35 mL deionized water and 45 mL anhydrous ethanol, adjusting pH value to 4-6 by dropwise adding nitric acid with concentration of 65%, stirring sufficiently and mixing evenly, and obtaining a solution II;

(4) dropwise adding the solution II into the solution I obtained in step (2) at a speed of 30-50 drops per minute under vigorous stirring to hydrolyze the tetrabutyl titanate completely, continually stirring for 2 hours and obtaining faint yellow, uniform and transparent titanium dioxide sol;

(5) immersing 3-5 mm glass ball into the above sol completely, loading the sol on the surface of the glass ball by dipping coating method, drying for 10 min in the air dry oven under 80° C., immersing dried glass ball into above sol, taking out and drying for 10 min in the air dry oven under 80° C. again, repeating such for 5-7 times, taking the obtained titanium dioxide sol down and placing in the air dry oven under 80° C. for completely drying for 8-12 hours and evaporating the solvent completely;

(6) placing the titanium dioxide sol obtained in step (5) in the muffle furnace, high-temperature calcining under 300-600° C. and keeping warm for 3-6 hours, taking out after cooling sufficiently, and obtaining 3.5% molybdenum doped titanium dioxide thin film.

### Embodiment 5

Preparation of 5% (n(Mo):n(Ti)=5%) molybdenum doped titanium dioxide thin film, and this embodiment comprises following steps:

(1) preparing into a mixed solution by mixing 30 mL tetrabutyl titanate, 5 mL acetylacetone and 90 mL anhydrous ethanol, stirring and mixing the mixed solution evenly, and the stirring time is 0.5 hour;

(2) adding 5 mL thickener polyethylene glycol (PEG200) into above stirred mixed solution, and stirring under 20-50° C. for completely dissolution, and obtaining a solution I;

(3) mixing 7.75 mL and 0.1 g/mL ammonium molybdate solution, 45 mL anhydrous ethanol, adjusting pH value to 4-6 by dropwise adding nitric acid with concentration of 65%, stirring sufficiently and mixing evenly, and obtaining a solution II;

(4) dropwise adding the solution Il into the solution I obtained in step (2) at a speed of 30-50 drops per minute under vigorous stirring to hydrolyze the tetrabutyl titanate completely, continually stirring for 2 hours and obtaining faint yellow, uniform and transparent titanium dioxide sol;

(5) immersing 3-5 mm glass ball into the above sol completely, loading the sol on the surface of the glass ball by dipping coating method, drying for 10 min in the air dry oven under 80° C., immersing dried glass ball into above sol, taking out and drying for 10 min in the air dry oven under 80° C. again, repeating such for 5-7 times, taking the obtained titanium dioxide sol and placing in the air dry oven under 80° C. for completely drying for 8-12 hours and evaporating the solvent completely;

(6) placing the titanium dioxide sol obtained in step (5) in the muffle furnace, high-temperature calcining under 300-600° C. and keeping warm for 3-6 hours, taking out after cooling sufficiently, and obtaining 5% molybdenum doped titanium dioxide thin film.

### Embodiment 6

Application of molybdenum doped titanium dioxide thin film in degrading volatile organic compounds (VOCs).

An experiment of photocatalytic degradation of toluene is carried out by simulating that main ingredients containing VOCs in the air are 78% nitrogen (N₂) and 21% oxygen (O₂), and toluene concentration is 10 ppm and placing the catalyst into the specially-made bushing type photocatalytic simulation testing apparatus, and the catalyst is molybdenum doped titanium dioxide thin film prepared in embodiment 2 under the condition that the relative humidity is 20-60%, operating temperature is 20-25° C., and simulative light source is 16 W and 254 nm. Results show that the degradation efficiency is higher than 94.6%, and the catalytic activity of 2% molybdenum doped titanium dioxide thin film is 1.48 times than that of pure titanium dioxide catalyst.

Above disclosure are some preferred embodiments to carry out the present invention, and they are merely some examples of the technical concept, and the present invention is not limited thereto. Any variations and equivalents made by those skilled in the art without departing from the spirit and scope of the technical proposal shall fall into the protection scope of the present invention.

We claim:

1. A method for preparing molybdenum doped titanium dioxide thin film by sol-gel, characterized in that the method comprises following steps:
(1) preparing a mixed solution by mixing tetrabutyl titanate, acetylacetone and anhydrous ethanol, stirring and mixing the mixed solution evenly;
(2) adding a thickener into the mixed solution obtained in step (1), stirring to complete dissolution under 20-50° C. and obtaining a solution I;
(3) mixing ammonium molybdate solution, deionized water and anhydrous ethanol, adjusting pH value to 4-6 by nitric acid, stirring sufficiently and mixing evenly, and obtaining a solution II;
(4) dropwise adding the solution II obtained in step (3) into the solution I obtained in step (2) under vigorous stirring to hydrolyze the tetrabutyl titanate completely, after the completion, continually stirring for 2 hours and obtaining a faint yellow, uniform and transparent titanium dioxide sol;
(5) immersing a glass ball into the titanium dioxide sol obtained in step (4) completely, loading the titanium dioxide sol on the glass ball surface by dipping coating method, oven drying in an air dry oven, immersing into the titanium dioxide sol again, oven drying again, repeating such for several times, taking multiple dipped and dried titanium dioxide sol, placing into a vacuum drying oven for completely drying, and evaporating a solvent completely;
(6) placing the titanium dioxide sot obtained in step (5) in a muffle furnace and carrying out high-temperature calcination, taking out after cooling completely, and obtaining molybdenum doped titanium dioxide thin film.

2. The method tor preparing molybdenum doped titanium dioxide thin film by sol-gel according to claim 1, characterized in that in step (1), the volume ratio of the tetrabutyl titanate, the acetylacetone and the anhydrous ethanol is 1:0.1-0.3:4-8.

3. The method for preparing molybdenum doped titanium dioxide thin film by sol-gel according to claim 1, characterized in that the mixed solution is stirred for 0.5-1 hour by a magnetic stirrer under room temperature for stirring and mixing the mixed solution evenly in step (1).

4. The method for preparing molybdenum doped titanium dioxide thin film by sol-gel according to claim 1, characterized in that the thickener in step (2) is one of polyethylene glycol and polyvinyl alcohol.

5. The method for preparing molybdenum doped titanium dioxide thin film by sol-gel according to claim 1, characterized in that the thickener in step (2) is one of polyethylene glycol.

6. The method for preparing molybdenum doped titanium dioxide thin film by sol-gel according to claim 1, characterized in that the dosage of the thickener in step (2) is 1-3 mL for each 10 mL tetrabutyl titanate.

7. The method for preparing molybdenum doped titanium dioxide thin film by sol-gel according to claim 1, characterized in that in step 3, the concentration of the ammonium molybdate solution is 0.1 g/mL, and the mass concentration of the nitric acid is 65 wt %.

8. The method for preparing molybdenum doped titanium dioxide thin film by sol-gel according to claim 1, characterized in that the dropwise adding speed in step (4) is 30-50 drops per minute.

9. The method for preparing molybdenum doped titanium dioxide thin film by sol-gel according to claim 1, characterized in that the diameter of the glass ball in step (5) is 3-5 mm.

10. The method for preparing molybdenum doped titanium dioxide thin film by sol-gel according to claim 1, characterized in that in step (5), the oven drying temperature for each time is 80° C., the oven drying time is 10 min, and the repeated times are 5-7; the drying temperature is 80° C. and drying time is 8-12 h.

11. The method for preparing molybdenum doped titanium dioxide thin film by sol-gel according to claim 1, characterized in that, a temperature of the high-temperature calcination in the step (6) is 300-600° C. and time for high-temperature calcination time is 3-6 hours.
